(19) United States
(12) Patent Application Publication
(10) Pub. No.: US 2007/0221093 A1
(43) Pub. Date: Sep. 27, 2007

(54) HYDROXYAPATITE-FORMING DENTAL MATERIAL WITH BIOACTIVE EFFECT

(75) Inventors: Albert Erdrich, Bad Nauheim (DE); Marcus Hoffmann, Usingen (DE); Andreas Piotrowski, Diez (DE)

Correspondence Address: NORRIS, MCLAUGHLIN & MARCUS, PA, 875 THIRD AVENUE, 18TH FLOOR, NEW YORK, NY, 10022, US

(73) Assignee: Heraeus Kulzer GmbH, Hanau (DE)

(21) Appl. No.: 11/687,937

(22) Filed: Mar. 19, 2007

(30) Foreign Application Priority Data
Mar. 23, 2006 (DE) 10 2006 013 854.6

(51) Int. Cl. C04B 28/34

(52) U.S. Cl. 106/35; 106/690

(57) ABSTRACT

The invention relates to a self-curing two-component dental material having as its components A powder component containing dicalcium phosphate anhydrate (DCPA) or dicalcium phosphate dihydrate (DCPD) and tetracalcium phosphate (TTCP) and B liquid component containing water and complexing agent, whereby crystalline DCPA having a crystal shape of small plates typical of brushite having an iron (Fe), manganese (Mn), molybdenum (Mo), and tungsten (W) content of less than 0.2 m % (200 ppm) each is used.

The invention relates to a self-curing hydroxyapatite-forming 2-component dental material with bioactive effect.

The hard tissue of human teeth consists mostly of the inorganic calcium phosphate compound, hydroxyapatite (Ca₁₀(PO₄)₆(OH)₂). For replacement, a multitude of filling materials based on different materials are available (e.g. amalgam, composites, glass ionomer cements). Although these ideally show biocompatible behavior in the tooth, usually there are no interactions between the healthy hard tissue of the tooth and the filling material.

Products for craniofacial surgery are on offer¹ that resemble human bone material. They are characterized by their biocompatibility, i.e. the materials are substituted own bone of the patient. Osteoclastic absorption and new bone formation in the body eventual lead to a gradual conversion to bone.
¹ Bone Source made by Leibinger Stryker, Norian CRS made by Synthes-Stratec

The powder components of these products consist of dicalcium phosphate anhydrate (DCPA) and tetracalcium phosphate (TTCP). A sodium monophosphate solution is used for preparation of the paste by mixing. The cement of the two products attains a compressive strength of approx. 60 and 30 MPa, respectively, after curing.

WO 94/20064 “Calcium phosphate hydroxyapatite precursor and methods for making and using the same” (inventors: L. J. Chow and S. Takagi) describes a calcium phosphate cement based on a TTCP with a Ca:P ratio of<2 and on another poorly soluble calcium phosphate salt, including DCPA. This cement is prepared by mixing with an 0.25 mmol/l H₃PO₄ solution and affords compressive strengths of 60 MPa. Moreover, proteins, fillers, vaccination germs, and viscosity-altering substances can be added. The materials is said to be suitable as dental filling material, remineralization substance, desensitizer, and bone replacement material.

WO 2004/103419 (inventors: J. Barralet, U. Gbureck, and R. Thull) relates to a calcium phosphate cement consisting of two powder components, whereby the first component has a particle diameter of d₅₀(comp1)<15 μm and the second component has a particle diameter of d₅₀(comp2)>d₅₀(comp1). Component 2 is 1.5- to 10-fold larger than component 1. An oligocarboxylic acid (e.g. trisodium citrate, disodium malate, disodium tartrate) is added to the mixing liquid in order to reduce the zeta-potential of the particles, which serves the purpose of improving the preparation-by-mixing properties of powder and liquid. An example specifies a cement made of the components, TTCP and DCPA, with sodium phosphate being added to its powder component as an accelerator of the setting reaction. This cement attains high compressive strength (˜100 MPa).

It is the object of the invention to provide another dental material with a bioactive effect. The term, “bioactive”, is mainly understood to refer to the capability of remineralization. The goal of remineralization is to deposit hydroxyapatite [(Ca₅(PO₄)₃OH)] such that it is taken up by the hard substance of the tooth. Remineralization is aimed to prevent further disintegration of the tooth and regenerate the substance of the tooth.

This object is met according to the invention by a self-curing 2-component dental material having as its components
powder component containing
   dicalcium phosphate anhydrate (DCPA) or dicalcium phosphate dihydrate (DCPD)
   tetracalcium phosphate (TTCP) and
liquid component containing
   water
   complexing agent from the group of Na₄-EDTA or Na₅-pentetate,
      whereby crystalline DCPA having a crystal shape of small plates typical of brushite having an iron (Fe), manganese (Mn), molybdenum (Mo), and tungsten (W) content of less than 0.2 m % (200 ppm) each is used.

The components are designed for preparation by mixing of a paste for application directly in the cavity. The paste cures therein by forming a new phase consisting mostly of hydroxyapatite (>95 wt-%). Since the composition is equal to that of the tooth, this filling material is capable of remineralization, which is also a capability of dental enamel.

The special dicalcium phosphate anhydrate (DCPA) or dicalcium phosphate dihydrate (DCPD) of the invention is needed to have a particularly reactive paste. It is used also in the synthesis of the tetracalcium phosphate (TTCP) employed here.

### LIST OF FIGURES

FIGS. 1, 2: Crystal shape of the special DCPA for the synthesis of the TTCP and in the powder mixture of the paste.

FIG. 3: Surface of the cured paste after 24 h.

FIGS. 4, 5: Remineralized surface of a test body after 44 weeks of exposure to artificial saliva (in-vitro experiment).

FIG. 6: Filling made of the cured paste in the natural tooth after 4 months of use, formation of a remineralized layer extending from the filling to the tooth (in-vivo experiment).

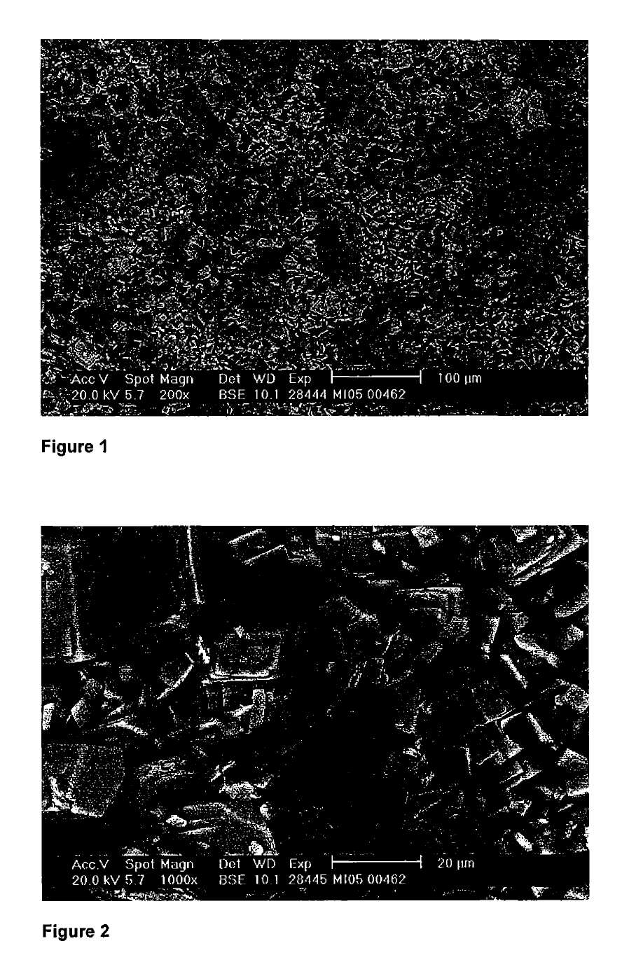

The DCPA is characterized by its purity with respect to the elements, iron (Fe) and manganese (Mn). The fraction of these substances must be less than 0.2 m % (200 ppm). Moreover, it must be very crystalline and form the crystal shape of small plates typical of brushite. The FIGS. 1 and 2 show scanning electron microscope images of the crystal morphology of the DCPA crystallites.

The TTCP synthesis is carried out according to known methods, such as described, for example, in WO9420064, except that the special DCPA described above is utilized for this purpose. An exemplary synthesis is described in the following:

The paste can be obtained by mixing the powder mixture made of DCPA and TTCP with an aqueous solution of Na₄-EDTA or Na₅-pentetate (400-700 mmol/l are useful). The complexing agents are added to improve the preparation by mixing of the paste and for processing in the dental application (application inside the cavity, carving).

Moreover, the paste cures with the hydroxyapatite particles forming a stronger bond than upon preparation-by-mixing using a Na₃-citrate solution, which does not lead to higher compressive strength, but shows higher abrasion stability. For application as a direct filling material, this property is quite important for a filling to be stabile.

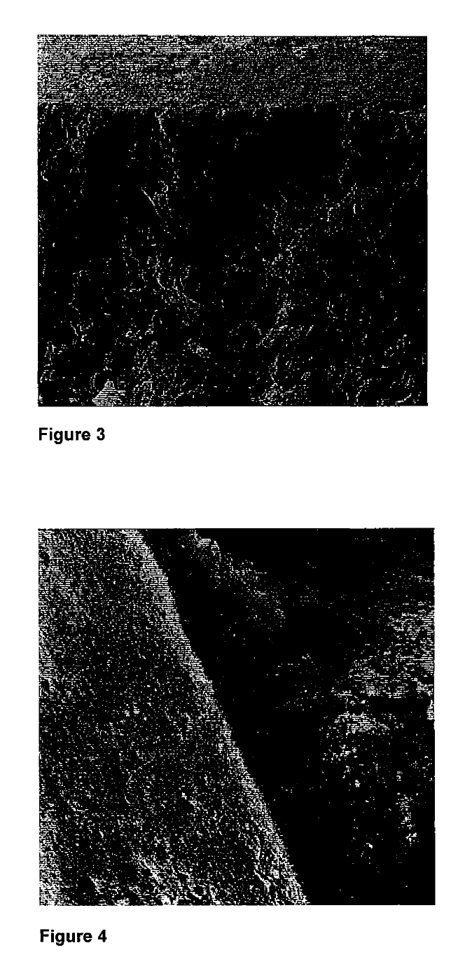

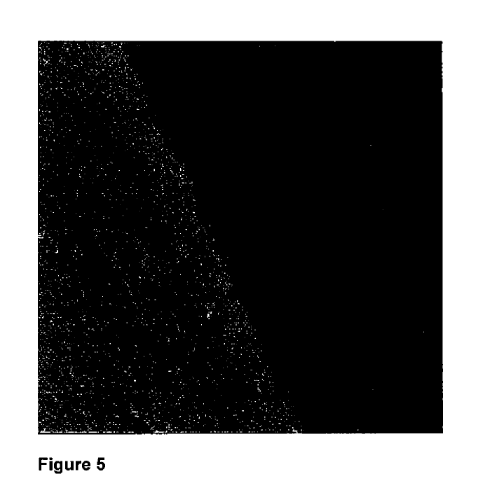

The bioactive effect of the cured paste was successfully demonstrated by means of in-vitro experiments. FIG. 3 shows the surface of a test body 24 h after the preparation. During storage of the test bodies in artificial saliva, remineralization led to the formation of a new structure (FIGS. 4 and 5). The shapeless particles are rearranged into prismatic structures that “grow” into the test body perpendicular to its surface, similar to enamel.

One advantage of the material according to the invention as compared to previously known systems is its high compressive strength combined with high abrasion stability. Known systems are mainly used in the area of bone replacement materials, in which the property of “abrasion stability” is not a crucial criterion. Application of the material as a dental filling material, though, necessitates stability with respect to mastication stress.

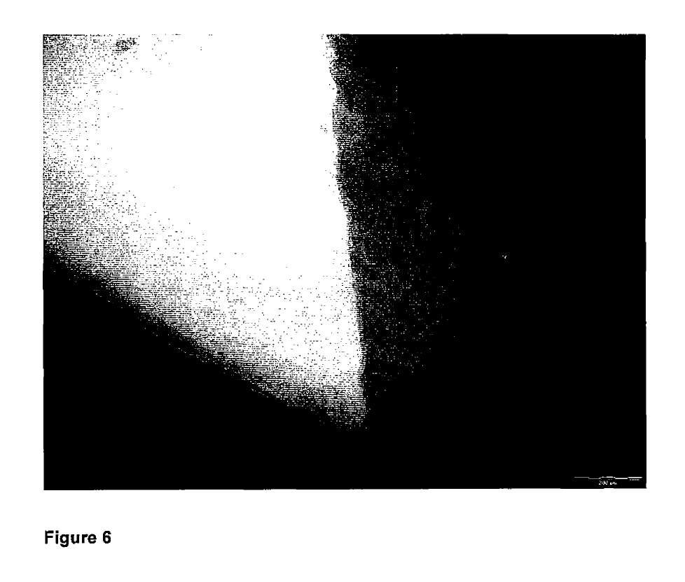

Another advantage of the material presented herein is that it is capable of remineralization. It was successfully shown in in-vitro and also in in-vivo experiments, that the material forms a new structure due to remineralization. Since the paste cures without changing its shape (no shrinkage and no expansion), no marginal gap between tooth and filling material is formed. Moreover, the filling mineralizes onto the healthy tissue of the tooth (FIG. 6: section of tooth 4 months after placement of the filling, in-vivo experiment).

The following example demonstrates one embodiment of the invention:

### EXAMPLE

A DCPA with a particle diameter (d₅₀) of 10-12 μm is used for synthesis of the TTCP. It is mixed with calcium carbonate (CaCO₃) at an equimolar ratio and subjected to tempering at 1400-1550° C. for 4-18 h. Once the reaction time is elapsed, the TTCP generated is removed from the furnace at the temperature of synthesis and then cooled at room temperature. For use in the powder mixture, the particle size (d₅₀) is adjusted to a diameter of 9-18 μm by trituration in a ball triturator. The DCPA in the powder mixture of the paste has a particle size of 0.5-3 μm and still possesses its plate-shaped crystal structure. Ideally, the particle size of the TTCP and DCPA is 10 μm and 1 μm, respectively.

A paste is obtained by mixing the powder mixture made of DCPA and TTCP with an aqueous Na₄-EDTA solution (500 mmol/l).

After curing, the material is subjected to testing in accordance with ISO 9917:2004. Compressive strength values of 90 MPa+/−7 MPa are thus obtained.

The long-term stability of the cured paste was in excess of 1 year.

The abrasion stability was investigated using the ACTA machine according to De Gee²³, ⁴ (De Gee, A. J., Pallav, P., Davidson, C. L.: Effect of abrasion medium on wear of stress-bearing composites and amalgam in vitro. J Dent Res 65, 654-658 (1986)). In the process, the paste according to the invention showed lower abrasion by a factor of two-thirds than the system according to WO 2004/103419.

1. Self-curing dental material comprising
A) powder component comprising i) dicalcium phosphate anhydrate (DCPA) or dicalcium phosphate dehydrate (DCPD) and ii) tetracalcium phosphate (TTCP) and
B) liquid component comprising water and a complexing agent,
wherein the DCPA has a crystal shape of small plates and wherein iron (Fe), manganese (Mn), molybdenum (Mo), and tungsten (W) are each present in the DCPA in an amount of less than 0.2 m % (200 ppm).

2. Dental material according to claim 1, wherein the complexing agent is selected from the group consisting of Na₄-EDTA and Na₅-pentetate.
